(19) United States
(12) Patent Application Publication
(10) Pub. No.: US 2016/0063229 A1
(43) Pub. Date: Mar. 3, 2016

(54) HYBRID ADAPTIVE AUTHENTICATION SCORING SYSTEM

(71) Applicant: Securemetric Technology Sdn Bhd, Kuala Lumpur (MY)

(72) Inventors: Law See Key, Kuala Lumpur (MY); Nioo Yu Siong, Kuala Lumpur (MY); Yau Wai Chung, Kuala Lumpur (MY)

(73) Assignee: SECUREMETRIC TECHNOLOGY SDN BHD, Kuala Lumpur (MY)

(21) Appl. No.: 14/843,665

(22) Filed: Sep. 2, 2015

(30) Foreign Application Priority Data
Sep. 2, 2014 (MY) PI 2014702457

(51) Int. Cl. G06F 21/31

(52) U.S. Cl. CPC G06F 21/316

(57) ABSTRACT

The present invention relates to a hybrid adaptive authentication scoring system. The system is combination of rules-cases based machine learning and also includes human in the decision making process whenever new cases are not found in system database. Based on defined policy that contains rules and user attributes, the system calculates a score that reflect risk for each request made by the user for completing the system authentication request. This is a continuous learning process and user attributes defines score for each transaction in one or more combination.

### FIELD OF INVENTION

The present invention relates to hybrid adaptive authentication scoring system and method. More particularly, relates to model, which determine score based system learning as well as allow user to define rules that also contributes to the scoring. In addition if new case discovered by system, it will include human decision that eventually recalculate the score.

### BACKGROUND OF THE INVENTION

Many of today's computer system allow users to access system through a password based or two factor authentications. Many times this is not sufficient to address latest system hacking such as phishing, man-in-the-middle, Man-in-the-browser, network sniffer etc.

In the present adaptive authentication provides two-factor authentication and dynamic risk evaluation processes. The “adaptive” element of the authentication platform learns a user's behavior and login environmental contextual to detect possible fraud.

Therefore, there is a need for a system and method which combines human decision in the machine learning process to calculate and enhance accuracy of score in term of trust that reflect the real world environment.

### SUMMARY OF THE INVENTION

A object of the present invention to provide a method for authenticating users comprising receiving a request for user authentication, wherein request for authentication comprises user identification information, determining one or more attributes associated with said user and a authentication rule associated with said attributes, generating a score for each authentication request, each score determines risk associated with said request, one or more authentication sub-processes is needed. In any combinations thereof, according to user input information for authentication process, authenticating user according to the authentication rules and agent decision responsive to user authentication requests, and configuring said rules in real-time, thereby allowing real-time authentication process risk validation.

A another object of the present invention to provide a system authenticating users, comprising a programmed processor, a databased operatively coupled to said processor, said database comprises one or more rules, users attributes information, receiving a request for user authentication, wherein request for authentication comprises user identification information, determining one or more attributes associated with said user and a rule associated with said attributes, generating a score for each rule, providing said score to a human agent, wherein agent determines risk associated with said request, one or more authentication sub-processes of information validation, fraud detection or identity verification,

A another object of the present invention provides a hybrid adaptive authentication scoring system as a result of combination of rules-cases based machine learning and include human in the decision making process whenever system detects new cases.

A another object of the present invention provides hybrid authentication scoring system, besides calculate score based on machine learning (Rules Based and Case Based, also enable users to define the rules based that contribute to the scoring as well. In addition system recommendation engine notifies user for decision making whenever unable to match specific user authentication environment attributes with database based on collected information and specific condition In each users authentication request from time to time, the final scores will able to reflect real world trust based on users access environment and behavior.

### BRIEF DESCRIPTION OF THE DRAWINGS

Other objects, features, and advantages of the invention will be apparent from the following description when read with reference to the accompanying drawings. In the drawings, wherein like reference numerals denote corresponding parts throughout the several views:

FIG. 1 illustrates hybrid adaptive authentication scoring system according to an embodiment of present invention.

FIG. 2 illustrates another schematic view of hybrid adaptive authentication scoring system according to an embodiment of present invention.

FIG. 3 illustrates a threshold based model used in decision making by the system according to an embodiment of present invention.

### DETAILED DESCRIPTION OF THE PREFERRED EMBODIMENTS

The present invention will now be described in detail with reference to the accompanying in drawings.

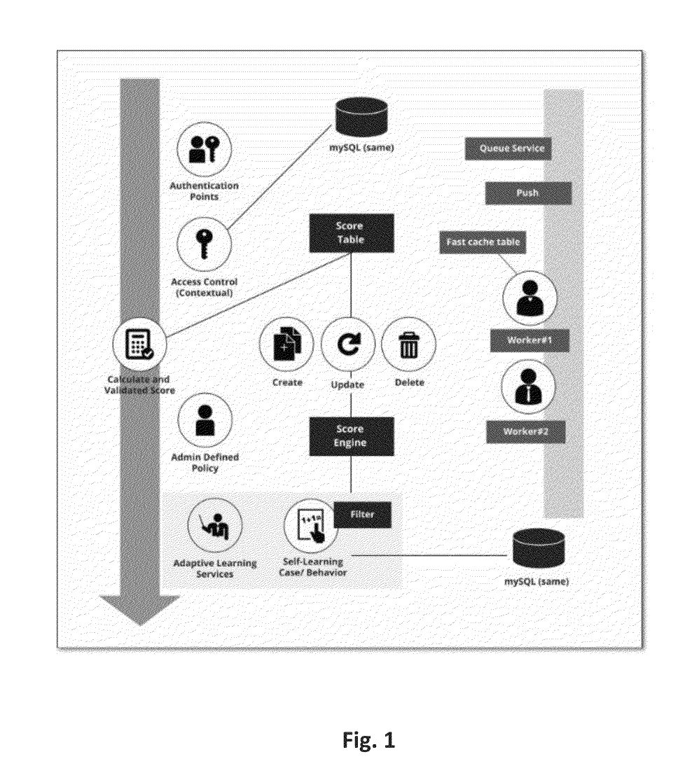

FIG. 1 illustrates hybrid adaptive authentication scoring system according to an embodiment of present invention. The system receives an authentication request from the user. Each user request comprises user identification information includes user details such as name, password, user system details such as OS, browser, time of day, IP address etc. the system further select one or more policies associated with user information. Based on the policy that contains multiple rules, a score is generated by the system and refer application risk level, notify users for 2^{nd} factor authentication. Here the authentication process comprises one or more sub process of information validation, fraud detection, identity verification of user provided information for the authentication of users login session. The user transaction authenticated by the user responsiveness of score analysis.

The system provides score-based, and behavior-based and machine learning based decision to decide the needs of 2^{nd} factor authentication after analyst user contextual attributes. The authentication rules define a multi-factor authentication process to authenticate the users. The multi-step user authentication processes are set according to defined policy that contains multiple rules. The authentication rules correspond to user attributes parameters, wherein the user attributes parameter correspond to time, OS, Browser, IP, Location and devices. The authentication rules define the user authentication process using real-time behavior information, and attributes parameter of the users. The user login authenticated by the online transaction server prior to assessing the fraud score level of the transaction, in which transaction server validates user authentication with scoring system on basis of usage such as per user basis. The system further collects user request data and storing the data for future score calculation.

The system comprises authentication point, access control mechanism, score engine to create update and modify score table. The system comprises a rule based database storing one or more user attributes specific rules for generating user authentication score. The system directed to rules based and cases based adaptive management, human intervention in the process notify by system and formula based scoring system.

In the system administrator defines white list and black listed for user access control based on environment “Contextual” attributes. Based on defined trust level by system administrator, calculate user accessibility scores before granted access to system. The system administrator defines some security policy of specific group of user's access.

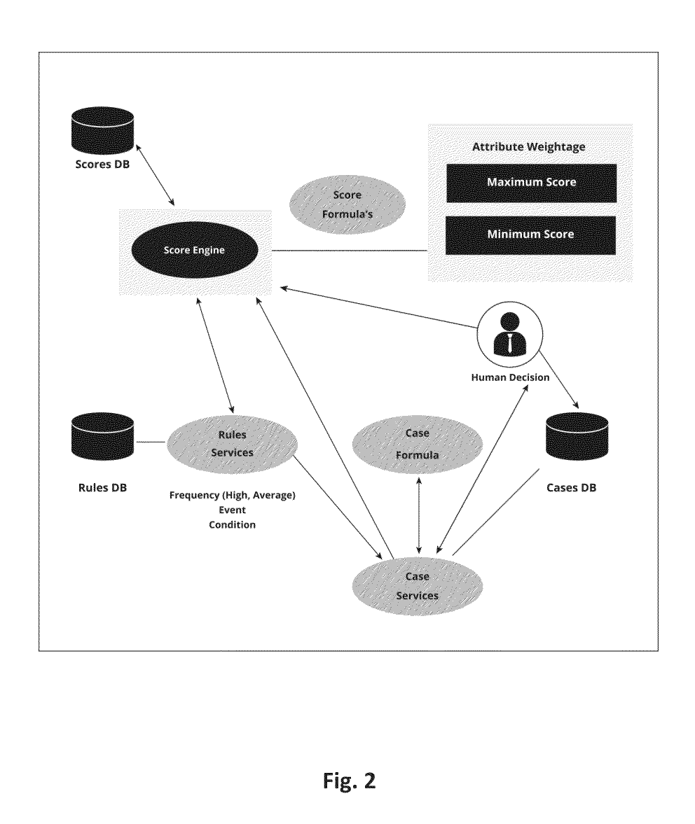

FIG. 2 illustrates services functionality in the system. The adaptive learning service is based on defined rules and collected environment contextual and update score databases. If rules not found in rules database, it treat the request, as new cases and save to case database. The case services pickup new cases and validate it based on defined formula. If formulas match with new case, it will submit to score engine for further processing. If formulas not match with new cases, it will prompt and ask for human decision whether to remove these cases and or submit to score engine for further processing. The score engine based on system score formulas and calculate the attribute score per user. Queue services to manage scores create, update and delete operation of score engine. User login environment attributes such as OS information, browser information and IP address are obtained for evaluation.

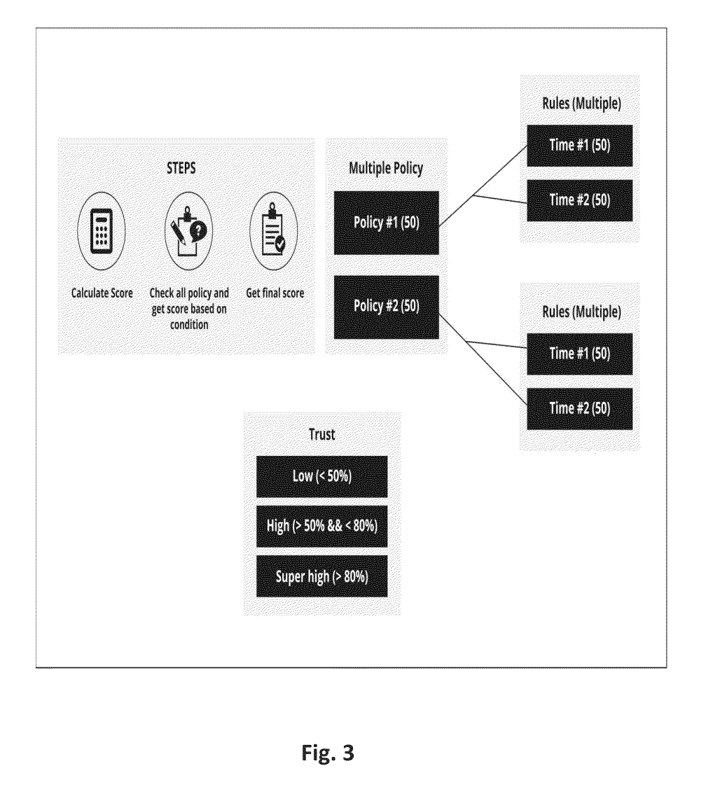

FIG. 3 illustrates a threshold based model used in decision making by the system according to an embodiment of present invention. The system comprises a policy engine includes number of policy implemented by the system during the authentication of user request. The rules apply over the policy and a score is generated. The score value is compared with predefined trust level associated with the transaction and based upon it level of trust such as low, high or super high is identified.

As will be readily apparent to those skilled in the art, the present invention may easily be produced in other specific forms without departing from its essential characteristics. The present embodiments is, therefore, to be considered as merely illustrative and not restrictive, the scope of the invention being indicated by the claims rather than the foregoing description, and all changes which come within therefore intended to be embraced therein.

1. A method for authenticating users, comprising:
receiving a request for user authentication, wherein request for authentication comprises user identification information;
determining one or more attributes associated with said user and an authentication rule associated with said attributes;
generating a score for each user authentication request.
providing said score to a system, wherein system determines risk associated with said request, one or more 2^{nd} factor authentication sub-processes. in any combinations thereof, according to user input information for authentication process;
authenticating user according to the authentication rules, contextual attributes, users behaviors and system decision responsive to user authentication requests, and
configuring said rules in real-time, thereby allowing real-time authentication process risk analyst.

2. The method of claim 1, wherein the authentication rules generates a score based on system defined risk analysis.

3. The method of claim 1, wherein additional security measurement is requested by requesting the users to validate second authentication on the basis of score based, and behavior based and machine learning-based decisions.

4. The method of claim 1, wherein the authentication rules define a multi-factor authentication process to authenticate the users.

5. The method of claim 1, wherein multi-step user authentication process is set according to a pre-defined policy.

6. The method of claim 1, wherein the authentication rules correspond to user attributes parameters.

7. The method of claim 1, wherein the user attributes parameter correspond to time, OS, Browser, IP, Location and devices.

8. The method of claim 1, wherein the authentication rules define the user authentication process using real-time behavior information, transaction information, attributes parameter of the users.

9. The method of claim 1, wherein the user login authenticated by the online transaction server prior to assessing the risk score level of the transaction.

10. The method of claim 1, further comprising setting, the score level of authentication after the start of transaction.

11. The method of claim 1, further comprising collecting user or transaction request data and storing the data for future risk assessment.

12. The method of claim 1, further comprising collecting transaction data and storing the transaction data for future risk assessment.

13. The method of claim 1, further comprising collecting user login environment contextual authentication data and storing the data for future authentication score calculation used.

14. The method of claim 1, further comprising authenticating a user for the transaction.

15. A system authenticating users, comprising:
a programmed processor;
a databased operatively coupled to said processor, said database comprises one or more rules, users behaviors information;
receiving a request for user authentication, wherein request for authentication comprises user identification information;
determining one or more attributes associated with said user and a rule associated with said attributes;
generating a score for each rule;
providing said score to a human agent, wherein agent determines risk associated with said request, one or more authentication sub-processes of information validation, fraud detection or identity verification, in any combinations thereof, according to user input information for authentication process;
authenticating user according to the authentication rules and agent decision responsive to user authentication requests, and
configuring said rules in real-time, thereby allowing real-time authentication process risk analysis

16. The system of claim 17, wherein the programmed processor further simulates authentication of the users according to the authentication rules.

17. The method of claim 17, wherein the authentication rules generates a score for risk analysis.

18. The method of claim 17, wherein the system provides score based and behavior based and machine learning based decision to reflect real environment risk.

19. The system of claim 17, wherein the programmed processor further correlates status information with the authentication rules.

20. The system of claim 17, wherein the programmed processor further generates user authentication examinations based upon the authentication rules in real-time.
